(19) United States
(12) Patent Application Publication
(10) Pub. No.: US 2026/0236320 A1
(43) Pub. Date: Aug. 13, 2026

(54) ELIMINATING SHORT-LIVED RESOURCES DURING DISCOVERY IN KUBERNETES ENVIRONMENT

(71) Applicant: ServiceNow, Inc., Santa Clara, CA (US)

(72) Inventors: Michael Avrahamov, San Francisco, CA (US); Tal Haim Kapon, Givatayim (IL)

(21) Appl. No.: 19/050,787

(22) Filed: Feb. 11, 2025

(51) Int. Cl. G06F 9/50

(52) U.S. Cl. CPC G06F 9/5077; G06F 2209/5011

(57) ABSTRACT

Embodiments of the subject technology relate to systems, methods, and computer-readable media for selectively reporting resources in a computing environment to a management system. Specifically, a resource is detected in a computing environment. The resource can be classified into a resource group. A lifespan of the resource in the computing environment can be predicted based on the resource group. Further, the resource can be selectively reported to a management system for the computing environment based on the predicted lifespan of the resource.

### BACKGROUND

### 1. Technical Field

The present disclosure generally relates to managing resources in a computing environment, and more specifically to discovering and selectively reporting short-lived resources in the computing environment.

### 2. Introduction

Systems have been developed that discover what resources are in a computing environment. In turn, such systems can report the discovered resources to a management system associated with managing one or more aspects of the computing environment. In particular, resource discovery and reporting are used in configuration management for various types of computing environments.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture for remotely managing computing environments, according to some examples of the present disclosure;

FIG. 3 illustrates a flowchart of an example method of selectively reporting a resource based on a resource group into which the resource is classified, according to some examples of the present disclosure;

FIG. 4 illustrates a flowchart of an example method of identifying an average lifespan of resources in a resource group, according to some examples of the present disclosure;

FIG. 5 illustrates a flowchart of an example method of selectively reporting a resource according to a suppression ratio, according to some examples of the present disclosure; and

FIG. 6 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Systems have been developed that discover what resources are in a computing environment. In turn, such systems can report the discovered resources to a management system associated with managing one or more aspects of the computing environment. In particular, resource discovery and reporting are used in configuration management for various types of computing environments.

Some computing environments are more dynamic than other environments. Specifically, resources in dynamic environments can have shorter lifespans, e.g. in comparison to less dynamic environments. In turn, reporting all or most discovered resources, including short-lived resources, to a management system can hamper performance related to operation of the management system. Specifically, reporting every discovered short-lived resource in a dynamic environment can lead to replication lag in a database, e.g. a configuration database, for managing the environment. Further, the database can grow indefinitely as table cleanup jobs are unable to catch up and delete all short-lived resources from the database once the resources are removed from the dynamic environment.

The disclosed technology addresses the foregoing by grouping resources in a computing environment into different resource groups. Each resource group can be associated with a resource lifespan for the resources in the resource group. In turn, a newly discovered resource in the computing environment can be classified into a resource group of the environment. As follows, a lifespan of the resource can be predicted based on the resource group into which the resource is classified. The existence of the resource in the computing environment can then be selectively reported to a management system for the computing environment based on the predicted lifespan of the resource. For example, if the lifespan of the resource is predicted to be short, e.g. based on the lifespan associated with the resource group, then a reporting system can refrain from reporting the resource back to the management system based on the short predicted lifespan. Alternatively, if the lifespan of the resource is predicted to be long, then the reporting system can report the resource back to the management system based on the long predicted lifespan.

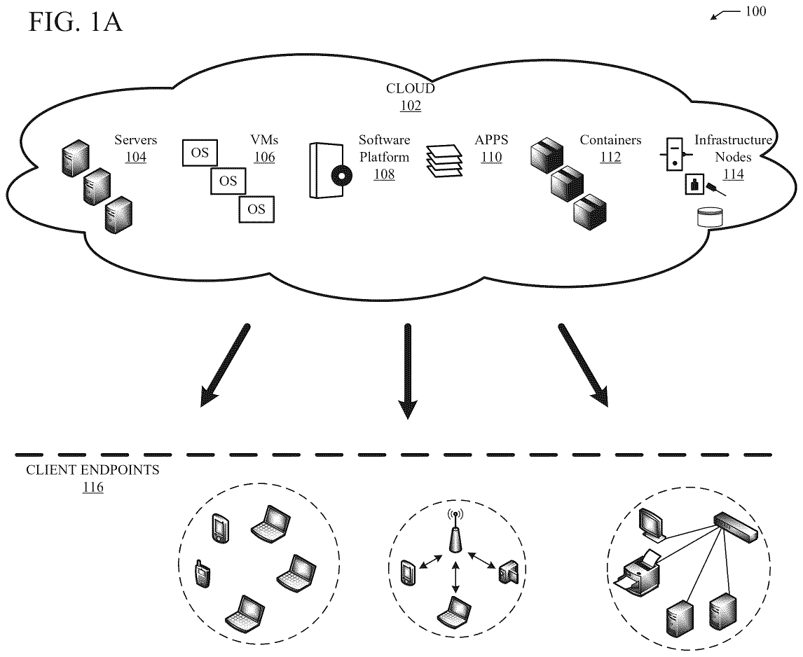

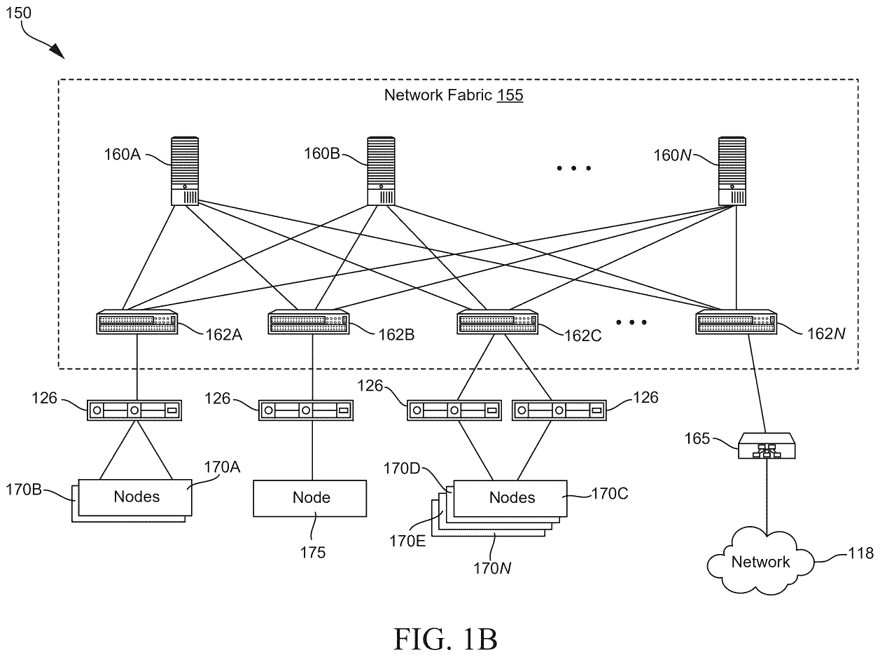

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

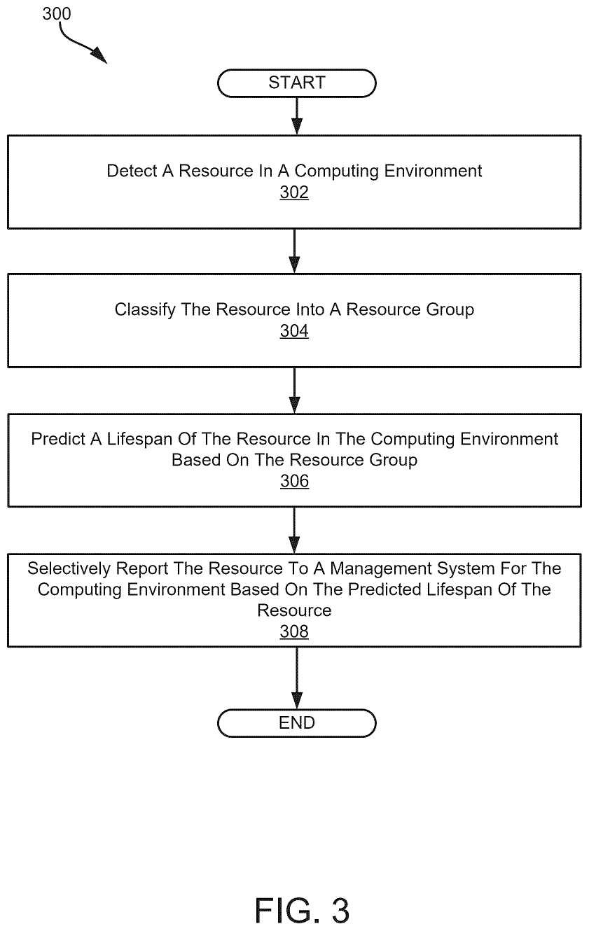

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B.

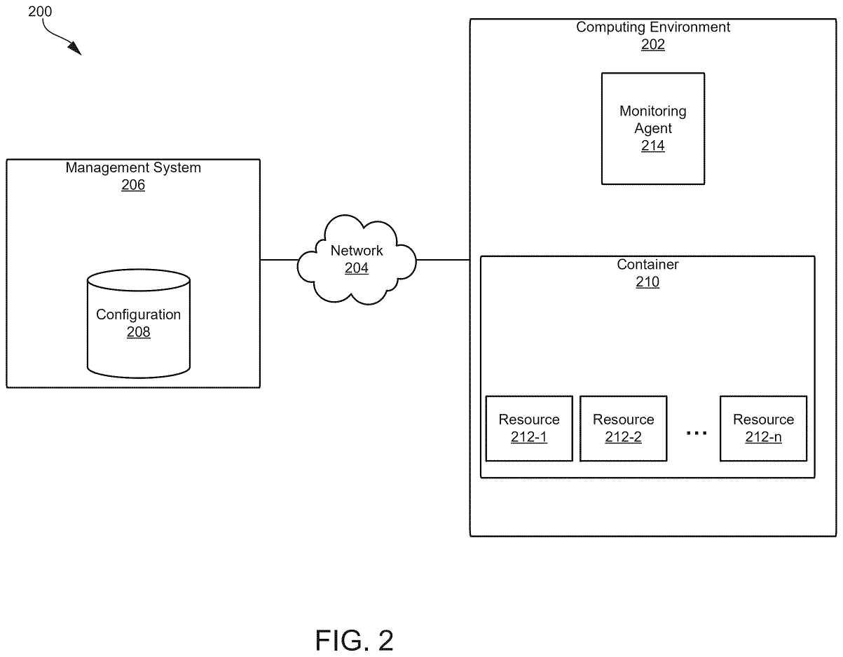

FIG. 2 illustrates a schematic diagram of an architecture 200 for remotely managing computing environments, according to some examples of the present disclosure. Specifically, the architecture includes a computing environment 202 coupled to a management system 206 through a network 204. The network 204 can be an applicable network for coupling the computing environment 202 to the management system 206, e.g. for providing remote management and monitoring capabilities to the management system 206.

The computing environment 202 comprises hardware, software, network(s), or a combination thereof for processing and performing tasks electronically. In various embodiments, the computing environment 202 can comprise a virtual computing environment. Specifically and as will be discussed in greater detail later, the computing environment 202 can support software containers and/or VMs.

The management system 206 functions to remotely monitor and provide functionalities for managing the computing environment 202, e.g. through the network 204. Specifically, the management system 206 can provide functionalities for managing applicable functionalities related to operations performed in the computing environment 202. For example, the management system 206 can provide functionalities for managing access to resources within the computing environment 202. Further, the management system 206 can provide functionalities for managing policies related to operations performed in the computing environment 202.

In monitoring and providing functionalities for managing the computing environment 202, the management system 206 can maintain configuration data of the computing environment 202. The configuration data maintained by the management system 206 can be stored in the configuration datastore 208. In maintaining such configuration data, the management system 206 can be referred to as a configuration management database (CMDB) for the computing environment 202. The management system 206 can maintain configuration data for an applicable hardware, software, devices (both real and virtual) that are supported within, or are otherwise associated with, the computing environment 202. Specifically, the management system 206 can maintain configuration data for configuration items which can comprise any or all of client devices, server devices, routers, VMs, software containers, any components thereof, any applications or services executing thereon, as well as relationships between devices, components, applications, and services. Thus, the term “configuration items” may be shorthand for part of all of any physical or virtual device, or any application or service remotely discoverable or managed by the management system 206, or relationships between discovered devices, applications, and services.

Configuration data maintained by the management system 206 can comprise applicable information describing characteristics of hardware, software, or devices, otherwise configuration items, associated with the computing environment 202. Specifically, configuration data can comprise a list of attributes that characterize the hardware or software that the configuration item represents. For example, attributes in the configuration data can comprise manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

The example computing environment 202 shown in FIG. 2 comprises a software container 210. The software container 210 can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). While a software container 210 is shown in the example computing environment 202 in FIG. 2, the computing environment 202 can support an applicable hardware component, software component, or device. For example, the computing environment 202 can support deployment of Kubernetes® clusters that run containerized workloads. As shown in FIG. 2, the container 210 comprises a first resource 212-1, a second resource 212-2, and up to an n^{th} resource 212-n, collectively referred to as resources 212. A resource, as used herein, can comprise an applicable unit of software, hardware, or a device that is supported in the computing environment 202. Further, resources can be added to and removed from the computing environment 202 over the lifespan of hardware, software, and devices associated with the computing environment 202. For example, the first resource 212-1 can be added to and removed from the computing environment as a specific process of software is executed in the container 210.

The computing environment 202 comprises a monitoring agent 214. The monitoring agent 214 functions to generate configuration information by monitoring the computing environment 202. Specifically, the monitoring agent 214 can gather/generate snapshots, as part of configuration information, of all or subsets of the computing environment. The snapshots can comprise applicable configuration information of software, hardware, and devices in the snapshot. The monitoring agent 214 can generate snapshots of the computing environment 202 at set times. For example, the monitoring agent 214 can generate snapshots of the computing environment 202 according to configurable intervals. Further, the monitoring agent 214 can generate a snapshot of the computing environment 202 in response to a change in the computing environment. For example, the monitoring agent 214 can generate a snapshot of the computing environment 202 in response to creation of a new resource in the computing environment 202.

Further, the monitoring agent 214 can detect changes that occur in the computing environment 202. In detecting changes in the computing environment 202, the monitoring agent 214 can identify configuration information for the computing environment 202 that correspond to the changes in the configuration information. Specifically, the monitoring agent 214 can identify when a resource has been added to the computing environment 202 and configuration information of the resource. Further, the monitoring agent 214 can identify when a change has occurred to a resource in the computing environment 202 and the configuration information of the changed resource. For example, the monitoring agent 214 can identify when a resource has been removed from the computing environment.

The monitoring agent 214 can report configuration information back to the management system 206. Specifically, the monitoring agent 214 can report configuration information of resources that have been added to the computing environment 202. Further, the monitoring agent 214 can report configuration information indicating which resources have been removed from the computing environment 202. For example, the monitoring agent 214 can report a snapshot of the computing environment 202 indicating which resources have been added to the computing environment 202 and which resources have been removed from the computing environment 202.

In various embodiments, resources can be short-lived in the computing environment 202. For example, a resource can be used for only ten minutes in executing software in a container and then be removed from the computing environment 202. As discussed previously, reporting every discovered short-lived resource in the computing environment 202 can lead to replication lag by the management system 206, e.g. for the configuration datastore 208, in managing the computing environment 202. Further, the configuration datastore 208 can grow indefinitely as table cleanup jobs are unable to catch up and delete all short-lived resources from the configuration datastore 208 once the resources are removed from the computing environment 202.

In order to overcome the deficiencies associated with reporting every detected resource, the monitoring agent 214 can be configured to selectively report detected resources in the computing environment 202 to the management system 206. Specifically, the monitoring agent 214 can refrain from reporting certain resources that are discovered in the computing environment 202 to the management system 206. More specifically, the monitoring agent 214 can refrain from reporting the existence of certain resources after the resources are discovered in the computing environment 202.

FIG. 3 illustrates a flowchart 300 of an example method of selectively reporting a resource based on a resource group into which the resource is classified, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example architectures described herein.

At module 302, a resource in a computing environment is detected. The computing environment can be an applicable dynamic environment in which resources are created, changed, and deleted at an applicable and quantifiable frequency. Specifically, the computing environment can support VMs and containers that are spun up and torn down daily. A dynamic environment can be defined based on whether reporting of every resource change in the environment would lead to issues associated with managing configuration data for the environment, e.g. replication lag and data cleanup issues. For example, an environment can be a dynamic environment if the rate at which resources are added, changed, and/or deleted in the environment causes problems associated with managing configuration data for the environment.

The resource can be a newly added resource in the computing environment or a changed resource in the computing environment, effectively a new resource in the computing environment. The resource can be detected through an applicable method and system for detecting newly created/spun up resources or modified resources in a computing environment. Specifically, the resource can be detected by a system, e.g. agent, that is integrated, at least in part, in the computing environment. The resource can be detected based on a snapshot for the computing environment. Specifically, a snapshot of resources in the computing environment can be analyzed to determine whether a resource has been added to the computing environment. For example, the resource can be part of a VM and detected by analyzing a snapshot that is an image of the VM in the computing environment.

At module 304, the resource is classified into a resource group. A resource group can comprise either or both past and current resources in one or more computing environments that are clustered together based on shared or similar characteristics between the resources. The resource can be classified into the resource group based on shared or similar characteristic(s) between the resource and the other resources in the resource group. Applicable characteristics of resources that can be used to cluster the resources together into groups and classify a resource into a resource group comprise a namespace associated with a resource, a hosting cluster associated with a resource, a name, a resource type, a name prefix, characteristics of an image associated with a resource, an identifier of the image, tags associated with a resource, or a combination thereof. For example, a resource can be classified into a resource group if it is the same type of resource running in the same type of software container.

Characteristics used for clustering resources to form resource groups can be customer specific. For example, different resource characteristics can define resource groups for different customers. Further, characteristics used for classifying resources into resource groups can be customer specific. For example, different resource tags can be used to classify resources into different resource groups for different customers. A customer can provide input specifying what characteristics to use in either or both forming resource groups and classifying resources into resource groups for the customer.

At module 306, a lifespan of the resource in the computing environment is predicted based on the resource group. Specifically, the resource group can be associated with a resource lifespan. As follows, a lifespan of the resource is predicted based on the resource lifespan associated with the resource group. The resource lifespan associated with the resource group, as will be discussed in greater detail later, can be identified based on resources that have been added to the resource group. In particular, the resource lifespan associated with the resource group can be identified based on the lifespan of resources that are classified into, or otherwise associated with, the resource group.

At module 308, the resource is selectively reported to a management system for the computing environment based on the predicted lifespan of the resource. Specifically, information related to the resource, including the existence of the resource in the computing environment, can be selectively reported to the management system for the computing environment. For example, characteristics of the resource, including a container or VM that is utilizing the resource, can be reported to the management system. In selectively reporting the resource to the management system, information relating to the resource, including the existence of the resource in the computing environment, can go unreported to the management system. Specifically, a monitoring agent can refrain from reporting the existing of the resource throughout the lifespan of the resource in the computing environment. Additionally, the monitoring agent can refrain from reporting a subset of the snapshot corresponding to the resource to the management system as part of selectively reporting the resource to the management system.

Selectively reporting the resource to the management system is technically advantageous as it can remedy the deficiencies created when every or most newly discovered resources in the computing environment are reported to the management system. More specifically, selectively reporting the resource to the management system is technically advantageous as it can remedy the deficiencies associated with reporting short-lived resources to the management system. For example, selectively reporting the resource to the management system can eliminate or decrease the occurrence of replication lag at the management system that is caused by reporting of short-lived resources. Further, selectively reporting the resource to the management system can facilitate timely and successful cleanup operations on configuration data maintained by the management system. In turn, continuous performance of the cleanup operations can help in ensuring that a configuration database does not grow indefinitely due to failed or missed cleanup operations.

In various embodiments, the resource can be removed from the resource group. Specifically, the resource can be removed from the resource group based on whether a lifespan of the resource exceeds the resource lifespan associated with the resource group. For example, if the lifespan of the resources exceeds the average lifespan of resources in the resource group, then the resource can be removed from the resource group. Removing the resource from the resource group is technically advantageous as it can ensure that the average lifespan of resources in the resource group is not distorted by anomalous resources. As follows, this can ensure that an accurate lifespan is predicted for resources classified into the group, leading to accurate selective reporting of the resources based on the predicted lifespan.

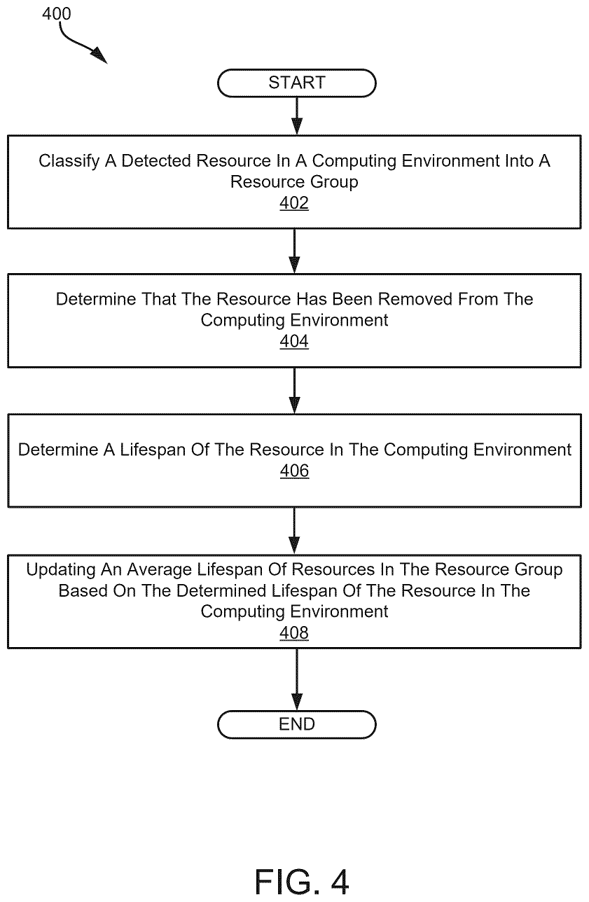

FIG. 4 illustrates a flowchart 400 of an example method of identifying an average lifespan of resources in a resource group, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, a detected resource in a computing environment is classified into a resource group. The resource can be classified into the resource group based on shared characteristics between the detected resource and the resources in the resource group. Specifically, the resource can be classified into the resource group based on matching between characteristics of the resource and the resources in the group relative to one or more thresholds. For example, if a threshold number of characteristics of the resource matches a threshold number of characteristics of the resources in the resource group, then the resource can be classified into the resource group. Characteristics can be matched, as used herein, based on applicable measures of similarity between resource characteristics. For example, names of resources can be matched if corresponding resource names are the same, e.g. within a threshold degree or amount. In another example, resource types can be matched if qualifications of the resource types match, e.g. within a threshold degree or amount.

At module 404, the resource is monitored to determine that the resource has been removed from the computing environment. The resource can be monitored by an applicable system, e.g. a monitoring agent, implemented in the computing environment to determine that the resource has been removed from the computing environment. For example, a snapshot of the computing environment can be analyzed to determine that the resource is absent from the snapshot and is therefore absent from the computing environment.

At module 406, a lifespan of the resource in the computing environment is determined. Specifically, the actual lifespan of the resource in the computing environment can be determined in response to determining that the resource has been removed from the computing environment. More specifically, the time at which the resource is removed from the computing environment, otherwise a current time, can be identified. In turn, the difference between the creation time of the resource and the time that the resource is removed from the computing environment can be the actual lifespan of the resource in the computing environment.

At module 408, an average lifespan of resources in the resource group is updated based on the determined lifespan of the resource in the computing environment. Specifically, the average lifespan of resources in the group can be recalculated based on the determined lifespan of the resource. Updating the average lifespan of resources in the resource group as new resources are classified into the group is technically advantageous as it can ensure an accurate average lifespan of the resources in the group is maintained. In turn, this can increase the accuracy of a lifespan of a resource that is predicted based on the average lifespan of the resources in the group.

Further, in classifying a resource into a group, a mapping data structure can be created that includes the map between the resource and a group name of the group. The mapping data structure can also comprise information about resources in the group, such as: deletion count, e.g. the number of deletions of resources in the group; a sum of the resource life span in seconds; a change count, e.g. the number of additions/modifications of resources in the group; and suppression rates indicating how many additions/modifications of resources were not reported, otherwise suppressed. Therefore in updating the average lifespan of resources in the resource group, the mapping data structure can be updated to reflect the deletion of the resource in the group.

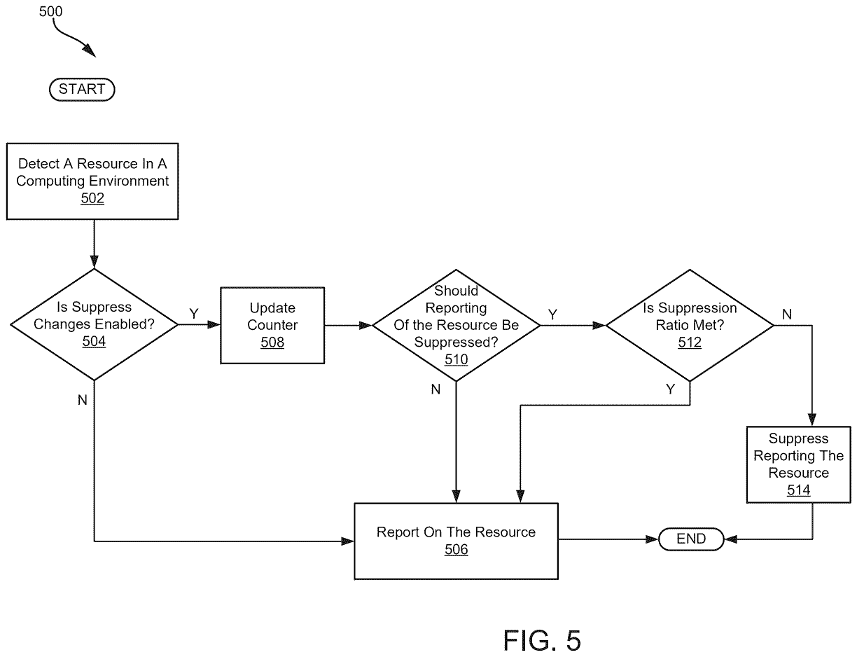

FIG. 5 illustrates a flowchart 500 of an example method of selectively reporting a resource according to a suppression ratio, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, a resource in a computing environment is detected. The resource can be a newly added resource in the computing environment or a changed resource in the computing environment, effectively a new resource in the computing environment. Next, the flowchart 500 continues to decision point 504, where it is determined whether a suppress changes feature is enabled. A suppress changes feature can specify to suppress, otherwise selectively report, newly added or changed resources in the computing environment to a management system for the computing environment.

If the suppress changes feature is not enabled, then the flowchart 500 continues to module 506, where the resource is reported to the management system for the computing environment. In turn, the management system can update configuration data for the computing environment based on the feature. If the suppress changes feature is enabled, then the flowchart 500 continues to module 508, where a counter is updated. The counter can be associated with a resource group and updated as newly added or changed resources are classified into the resource group. Further, the counter can be reset at a configurable periodicity, e.g. every day.

Next the flowchart 500 continues to decision point 510 where it is determined whether to suppress reporting of the resource to the management system. Specifically, the technology described herein can be applied to determine whether to suppress the reporting of the resource. More specifically, it can be determined whether to suppress the reporting of the resource based on a predicted lifespan of the resource, as determined according to the technology described herein. If it is determined to not suppress reporting of the resource at decision point 510, then the flowchart 500 can continue to module 506, where the resource is reported to the management system.

If it is determined to suppress reporting of the resource at decision point 510, then the flowchart 500 can continue to decision point 512. At decision point 512, it is determined whether a suppression ratio is met. The suppression ratio can specify reporting a resource if the ratio is met. Specifically, the suppression ratio can be a threshold, e.g. number of changed and/or new resources detected in the computing environment for a given time. In turn, whether the suppression ratio is met can include if the number of changed and/or new resources is greater than or equal to the threshold. Further, whether the suppression ratio is met can include if the number of changed and/or new resources is less than or equal to the threshold

The suppression ratio can be specific to the computing environment or one or more resource groups associated with the computing environment. For example, if the suppression ratio for the resource group that the resource is classified into is met, then the flowchart 500 can continue to module 506, where the resource is reported to the management system. If it is determined at decision point 512 that the suppression ratio is not met, then the flowchart 500 continues to module 514, where reporting of the resource is suppressed. Specifically, a monitoring agent can refrain from reporting the resource to the management system at module 514. Suppressing resource reporting according to a suppression ratio is technically advantageous as it can still allow for the reporting of some short-lived resources to the management system. Accordingly, the maintained configuration data of the computing environment can still accurately reflect the configuration in the computing environment, as opposed to the scenario where the reporting of every newly added or changed resource is suppressed. Further, use of the suppression ratio can ensure that several short-lived resources are not reported, thereby reducing or eliminating replication lag and ensuring effective cleanup operations are performed on maintained configuration data.

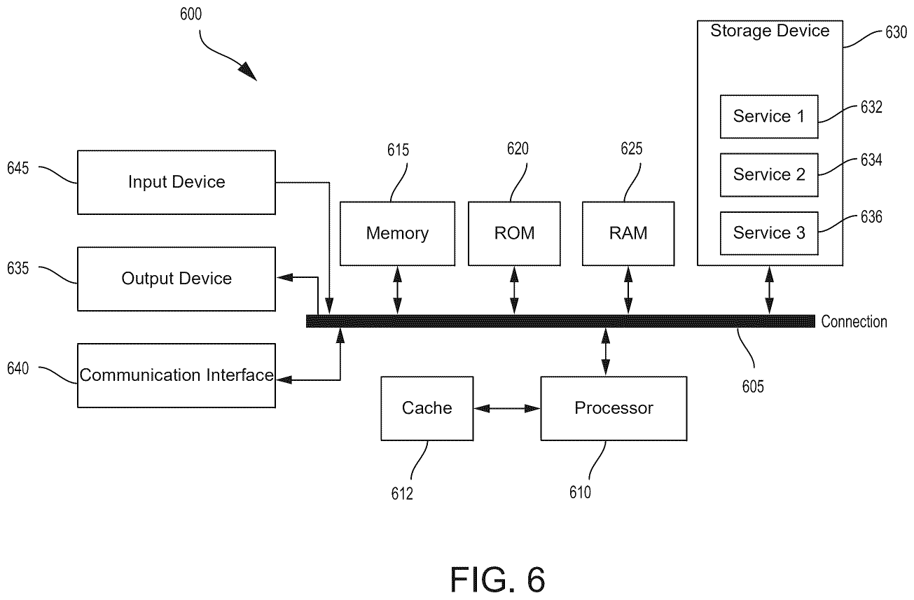

FIG. 6 illustrates an example processor-based system with which some embodiments of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative Examples of the Disclosure Include:

Embodiment 1. A computer-implemented method comprising: detecting a resource in a computing environment; classifying the resource into a resource group; predicting a lifespan of the resource in the computing environment based on the resource group; and selectively reporting the resource to a management system for the computing environment based on the predicted lifespan of the resource.

Embodiment 2. The computer-implemented method of Embodiment 1, wherein the resource group is associated with a resource lifespan and the lifespan of the resource is predicted based on the resource lifespan associated with the resource group.

Embodiment 3. The computer-implemented method of Embodiment 2, wherein the resource lifespan associated with the resource group is determined based on resources that have been added to the resource group.

Embodiment 4. The computer-implemented method of either of Embodiments 2 or 3, further comprising: detecting deletion of a resource in the resource group from the computing environment; identifying a creation time and a deletion time of the resource in the resource group; identifying a lifespan of the resource in the resource group; and updating an average lifespan of resources in the resource group based on the lifespan of the resource in the resource group, wherein the resource lifespan associated with the resource group is the average lifespan of the resources in the resource group.

Embodiment 5. The computer-implemented method of Embodiment 4, wherein the average lifespan of the resources in the resource group is updated based on the lifespan of the resource in the resource group and a counter associated with a number of the resources in the resource group, the method further comprising incrementing the counter in response to classifying the resource to the resource group.

Embodiment 6. The computer-implemented method of any of Embodiments 1 through 5, further comprising removing the resource from the resource group based on whether a lifespan of the resource exceeds the resource lifespan associated with the resource group.

Embodiment 7. The computer-implemented method of any of Embodiments 1 through 6, further comprising classifying the resource into the resource group based on characteristics of resources in the resource group and characteristics of the resource.

Embodiment 8. The computer-implemented method of Embodiment 7, wherein the characteristics of the resource and the characteristics of the resources in the resource group comprise a namespace, a hosting cluster, a name, a resource type, characteristics of an image, an identifier of the image, tags, or a combination thereof.

Embodiment 9. The computer-implemented method of Embodiment 7, wherein the characteristics of the resources in the resource group and the characteristics of the resource are selected based on a customer.

Embodiment 10. The computer-implemented method of any of Embodiments 1 through 9, further comprising detecting the resource from a snapshot of resources in the computing environment.

Embodiment 11. The computer-implemented method of Embodiment 10, further comprising refraining from reporting a subset of the snapshot corresponding to the resource to the management system as part of selectively reporting the resource to the management system.

Embodiment 12. The computer-implemented method of Embodiment 10, wherein the resource is a resource of a virtual machine and the snapshot is part of an image of the virtual machine in the computing environment.

Embodiment 13. The computer-implemented method of any of Embodiments 1 through 12, further comprising selectively reporting the resource to the management system according to a suppression ratio.

Embodiment 14. A system comprising: one or more processors; and at least one computer-readable storage medium having stored therein instructions which, when executed by the one or more processors, cause the one or more processors to: detect a resource in a computing environment; classify the resource into a resource group; predict a lifespan of the resource in the computing environment based on the resource group; and selectively report the resource to a management system for the computing environment based on the predicted lifespan of the resource.

Embodiment 15. The system of Embodiment 14, wherein the resource group is associated with a resource lifespan and the lifespan of the resource is predicted based on the resource lifespan associated with the resource group.

Embodiment 16. The system of Embodiment 15, wherein the resource lifespan associated with the resource group is determined based on resources that have been added to the resource group.

Embodiment 17. The system of Embodiment 15, wherein the instructions further cause the one or more processors to: detect deletion of a resource in the resource group from the computing environment; identify a creation time and a deletion time of the resource in the resource group; identify a lifespan of the resource in the resource group; and update an average lifespan of resources in the resource group based on the lifespan of the resource in the resource group, wherein the resource lifespan associated with the resource group is the average lifespan of the resources in the resource group.

Embodiment 18. The system of any of Embodiments 14 through 17, wherein the instructions further cause the one or more processors to classify the resource into the resource group based on characteristics of resources in the resource group and characteristics of the resource.

Embodiment 19. The system of any of Embodiments 14 through 18, wherein the instructions further cause the one or more processors to detect the resource from a snapshot of resources in the computing environment.

Embodiment 20. A non-transitory computer-readable storage medium storing instructions for causing one or more processors to: detect a resource in a computing environment; classify the resource into a resource group; predict a lifespan of the resource in the computing environment based on the resource group; and selectively report the resource to a management system for the computing environment based on the predicted lifespan of the resource.

Embodiment 21. A system comprising means for performing a method according to any of Embodiments 1 through 13.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
detecting a resource in a computing environment;
classifying the resource into a resource group;
predicting a lifespan of the resource in the computing environment based on the resource group; and
selectively reporting the resource to a management system for the computing environment based on the predicted lifespan of the resource.

2. The computer-implemented method of claim 1, wherein the resource group is associated with a resource lifespan and the lifespan of the resource is predicted based on the resource lifespan associated with the resource group.

3. The computer-implemented method of claim 2, wherein the resource lifespan associated with the resource group is determined based on resources that have been added to the resource group.

4. The computer-implemented method of claim 2, further comprising:
detecting deletion of a resource in the resource group from the computing environment;
identifying a creation time and a deletion time of the resource in the resource group;
identifying a lifespan of the resource in the resource group; and
updating an average lifespan of resources in the resource group based on the lifespan of the resource in the resource group, wherein the resource lifespan associated with the resource group is the average lifespan of the resources in the resource group.

5. The computer-implemented method of claim 4, wherein the average lifespan of the resources in the resource group is updated based on the lifespan of the resource in the resource group and a counter associated with a number of the resources in the resource group, the method further comprising incrementing the counter in response to classifying the resource to the resource group.

6. The computer-implemented method of claim 2, further comprising removing the resource from the resource group based on whether a lifespan of the resource exceeds the resource lifespan associated with the resource group.

7. The computer-implemented method of claim 1, further comprising classifying the resource into the resource group based on characteristics of resources in the resource group and characteristics of the resource.

8. The computer-implemented method of claim 7, wherein the characteristics of the resource and the characteristics of the resources in the resource group comprise a namespace, a hosting cluster, a name, a resource type, characteristics of an image, an identifier of the image, tags, or a combination thereof.

9. The computer-implemented method of claim 7, wherein the characteristics of the resources in the resource group and the characteristics of the resource are selected based on a customer.

10. The computer-implemented method of claim 1, further comprising detecting the resource from a snapshot of resources in the computing environment.

11. The computer-implemented method of claim 10, further comprising refraining from reporting a subset of the snapshot corresponding to the resource to the management system as part of selectively reporting the resource to the management system.

12. The computer-implemented method of claim 10, wherein the resource is a resource of a virtual machine and the snapshot is part of an image of the virtual machine in the computing environment.

13. The computer-implemented method of claim 1, further comprising selectively reporting the resource to the management system according to a suppression ratio.

14. A system comprising:
one or more processors; and
at least one computer-readable storage medium having stored therein instructions which, when executed by the one or more processors, cause the one or more processors to:
detect a resource in a computing environment;
classify the resource into a resource group;
predict a lifespan of the resource in the computing environment based on the resource group; and
selectively report the resource to a management system for the computing environment based on the predicted lifespan of the resource.

15. The system of claim 14, wherein the resource group is associated with a resource lifespan and the lifespan of the resource is predicted based on the resource lifespan associated with the resource group.

16. The system of claim 15, wherein the resource lifespan associated with the resource group is determined based on resources that have been added to the resource group.

17. The system of claim 15, wherein the instructions further cause the one or more processors to:
detect deletion of a resource in the resource group from the computing environment;
identify a creation time and a deletion time of the resource in the resource group;
identify a lifespan of the resource in the resource group; and
update an average lifespan of resources in the resource group based on the lifespan of the resource in the resource group, wherein the resource lifespan associated with the resource group is the average lifespan of the resources in the resource group.

18. The system of claim 14, wherein the instructions further cause the one or more processors to classify the resource into the resource group based on characteristics of resources in the resource group and characteristics of the resource.

19. The system of claim of claim 14, wherein the instructions further cause the one or more processors to detect the resource from a snapshot of resources in the computing environment.

20. A non-transitory computer-readable storage medium storing instructions for causing one or more processors to:
detect a resource in a computing environment;
classify the resource into a resource group;
predict a lifespan of the resource in the computing environment based on the resource group; and
selectively report the resource to a management system for the computing environment based on the predicted lifespan of the resource.
